(19) United States
(12) Patent Application Publication
(10) Pub. No.: US 2010/0259399 A1
(43) Pub. Date: Oct. 14, 2010

(54) MOBILE COMMUNICATION DEVICE CONFIGURED TO SENSE EXTERNAL CABLE

(75) Inventor: Yoshihiro TANNO, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/699,467

(22) Filed: Feb. 3, 2010

(30) Foreign Application Priority Data
Apr. 10, 2009 (JP) P2009-96296

(51) Int. Cl. G08B 21/00

(52) U.S. Cl. 340/635

(57) ABSTRACT

A mobile communication device configured to be connected to a first external cable is provided. The mobile communication device has a connector configured to be connected to the first external cable, and has an interface and a controller. The interface has a first sensing port, and a first circuit connected to the connector and to the first sensing port. The first circuit is configured such that the first sensing port is provided with a voltage level that changes depending on whether the connector is open or connected to the first external cable. The controller is connected to the first sensing port. The controller is configured to perform an interruption process so as to perceive the connection of the first external cable upon sensing a change of the voltage level at the first sensing port.

### CROSS REFERENCE TO RELATED APPLICATIONS

This application is based upon and claims the benefit of priority from the prior Japanese Patent Application No. 2009-96296 filed on Apr. 10, 2009;

the entire contents of which are incorporated herein by reference.

### BACKGROUND OF THE INVENTION

1. Field of the Invention

The present invention relates to a mobile communication device configured to sense an external cable connected to the mobile communication device.

2. Description of the Related Art

It is preferable for a mobile communication device to decrease the number of external interface connectors from a viewpoint of size, weight, design, etc. A mobile data terminal having a connector for common use in order to decrease the number of connectors is known, e.g., as disclosed in Japanese Patent Publication of Unexamined Applications (Kokai), No. 2002-50978. According to JP-A-2002-50978, as shown in FIGS. 1-9 and paragraphs 0042-0044, a mobile phone 13 that is a first embodiment of the mobile data terminal has a 4-terminal earphone/microphone jack 11 as a connector for common use. A plug 10 (FIG. 2) of a digital still camera 1, a plug (FIG. 7) of an earphone/microphone or a plug (FIG. 8) of a stereo headphone is connected from the outside to the earphone/microphone jack 11. The mobile phone 13 automatically senses which of the above plugs is connected as explained below.

A resistance characteristic between certain terminals of one of the above plugs is peculiar to that plug and is different from a characteristic between the same terminals of another one of the plugs. The plug 10 (FIG. 2) of the digital still camera 1 has an infinite resistance between a clock line portion 11 c (second contact) and a ground portion 11 b (third contact) which are isolated. The plug (FIG. 7) of the earphone/microphone has resistance values between an earphone terminal portion 73 (second contact) and a ground portion 72 (third contact) and between a microphone terminal portion 74 (first contact) and the ground portion 72 (third contact) which are different from each other. The plug (FIG. 8) of the stereo headphone has resistance values between a stereo (R) terminal portion 84 (second contact) and a ground portion 82 (third contact) and between a stereo (L) terminal portion 83 (first contact) and the ground portion 82 (third contact) are nearly equal to each other.

Upon sensing a plug connected to the earphone/microphone jack 11, the switch controller 25 of the mobile phone 13 senses a resistance value between the second and third contacts counted from the tip of the connected plug. If the sensed resistance value is infinite, the switch controller 25 judges that the digital still camera 1 has been connected. Unless the sensed resistance value is infinite, the switch controller 25 compares the resistance values between the second and third contacts and between the first and third contacts. If the compared resistance values are different from each other, the switch controller 25 judges that the earphone/microphone has been connected. If the compared resistance values are nearly equal to each other, the switch controller 25 judges that the stereo headphone has been connected.

According to paragraphs 0051-0054 of JP-A-2002-50978, a connector 101 (FIG. 12) of a USB cable 100 is connected from the outside to an earphone/microphone jack 11 that is a connector for common use of a mobile phone 113 of a second embodiment. An external device is connected to another connector 102 of the USB cable 100. A switch controller 125 of the mobile phone 113 senses a certain operation such as a mode change performed by a user so as to sense the USB cable 100 being connected. Further, the switch controller 125 identifies a certain signal transmitted from an external device so as to recognize the external device.

A signal switch circuit of a video/audio device having a connector for common use is known, e.g., as disclosed in Japanese Patent Publication of Unexamined Applications (Kokai), No. 2000-32339. The signal switch circuit (FIG. 2 or FIG. 1) of the video/audio device has a jack 1 that is a connector for common use. An AV cable or a headphone cable shown in FIG. 3 is connected from the outside to the Jack 1. The signal switch circuit automatically senses which of the above cables is connected as explained below.

According to paragraphs 0013-0014 and FIG. 2 of JP-A-2000-32339, a resistance value connected from a 1A terminal of the jack 1 to the outside is more than a couple of dozens of kilohms and fewer than a couple of hundred ohms in cases of the AV cable and the headphone cable, respectively. The signal switch circuit senses a voltage level of ADHET divided by a resistor R5 so as to judge which of the cables has been connected. Further, according to paragraphs 0032-0034 and FIG. 1 of JP-A-2000-32339, a resistance value connected from a 1D terminal of the jack 1 to the outside is more than a couple of dozens of kilohms and 0 (grounded) in cases of the AV cable and the headphone cable, respectively. As a connection condition of a transistor Q2 changes, the signal switch circuit senses the voltage level of ADHET, i.e., a collector voltage level of the transistor Q2, so as to judge which of the cables has been connected.

The mobile data terminal of JP-A-2002-50978 judges which of the plug 10 of the digital still camera 1, the plug of the earphone/microphone and the plug of the stereo headphone is connected depending on whether the resistance value of the plug is infinite or not, etc. Further, the mobile data terminal senses a USB cable upon sensing a certain operation performed by a user. Further, only how to judge what kind of plug has been connected is disclosed, and nothing is disclosed concerning how to sense a moment of the connection.

The video/audio device of JP-A-2000-32339 senses a voltage level indicating a difference of resistance values of the AV cable and the headphone cable, and thereby senses which of the cables is connected. Further, the video/audio device senses the difference of the resistance values depending on a change of a state of connections of the transistor Q2. Further, only how to judge what kind of cable has been connected is disclosed, and nothing is disclosed concerning how to sense a moment of the connection.

### SUMMARY OF THE INVENTION

Accordingly, an advantage of the present invention is to sense what is connected to a mobile communication device such as a USB client cable, a USB host cable, a conversion cable for audio use, a plurality of kinds of devices such as an earphone connected to an end of the conversion cable soon after the connection is done, and to automatically sense what kind of thing is connected.

To achieve the above advantage, according to one aspect of the present invention, a mobile communication device configured to be connected to a first external cable is provided. The mobile communication device has a connector configured to be connected to the first external cable, and has an interface and a controller. The interface has a first sensing port, and a first circuit connected to the connector and to the first sensing port. The first circuit is configured such that the first sensing port is provided with a voltage level that changes depending on whether the connector is open or connected to the first external cable. The controller is connected to the first sensing port. The controller is configured to perform an interruption process so as to perceive the connection of the first external cable upon sensing a change of the voltage level at the first sensing port.

### BRIEF DESCRIPTION OF THE DRAWINGS

FIG. 1 illustrates system constituted by a mobile communication device 50 of an embodiment of the present invention and external cables, etc.

FIG. 2 is a block diagram of portions related to the mobile communication device 50 of the embodiment of the present invention.

FIGS. 3A-3D are timing charts (1/2) for cable sensing of the mobile communication device 50 of the embodiment of the present invention.

FIGS. 4B and 4E are timing charts (2/2) for cable sensing of the mobile communication device 50 of the embodiment of the present invention.

FIG. 5 is an operation flowchart of an initialization process of a cable sensing function 10 of the mobile communication device 50 of the embodiment of the present invention.

FIGS. 6A and 6B are an operation flowchart of an interruption process of the cable sensing function 10 of the mobile communication device 50 of the embodiment of the present invention.

### DETAILED DESCRIPTION OF THE INVENTION

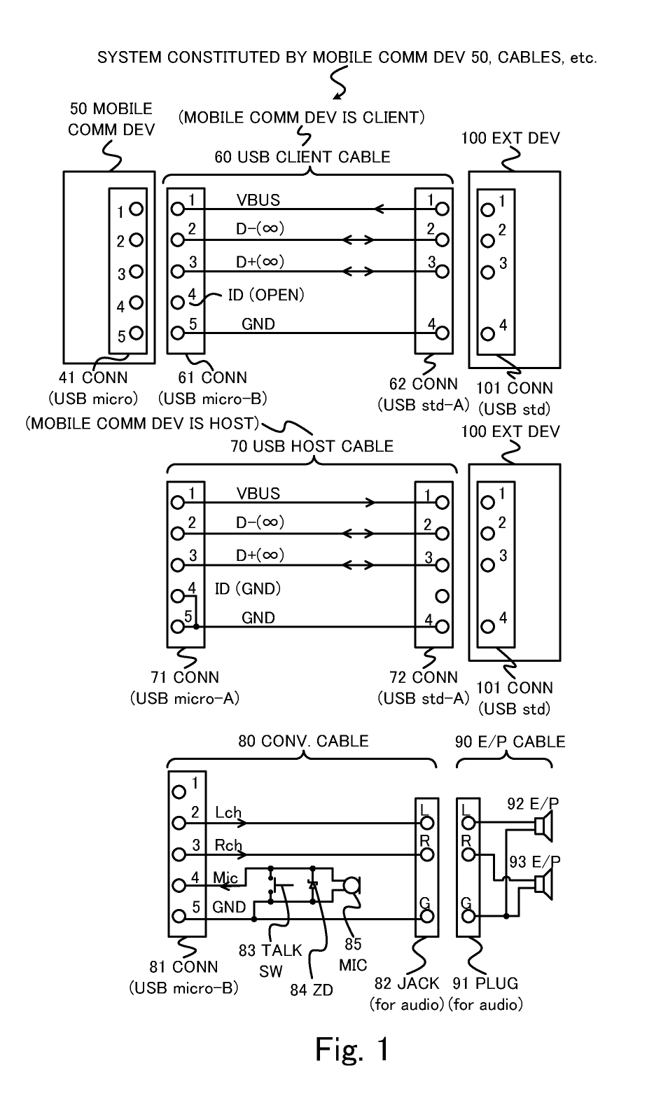

FIG. 1 illustrates a system constituted by a mobile communication device 50, external cables, etc. The mobile communication device 50 is configured to automatically distinguish a kind of cable for external connection, etc. Structures of such cables will be explained in detail below.

The mobile communication device 50 has a connector 41 that is a connector for common use to be connected to various kinds of external cables. The connector 41 is a small-sized USB micro connector having a shape according to the USB specification.

Various kinds of cables such as a USB client cable 60, a USB host cable 70 and an audio-use conversion cable 80 can be connected from the outside to the connector 41. An earphone cable 90 can be connected at the end of the conversion cable 80. The conversion cable 80 is provided as the earphone cable 90 has a circular plug 91 that cannot be directly connected to the connector 41 of the mobile communication device 50 according to the USB specification.

An external device 100 such as a personal computer is connected to the other end of the USB client cable 60 or of the USB host cable 70. The mobile communication device 50 and the external device 100 perform communication in accordance with the USB protocol between each other.

Then, each of the above cables will be explained. Arrows shown on signal lines of the cables each indicate directions of respective signals.

### (USB Client Cable 60)

The USB client cable 60 has a connector 61 and a connector 62 to be connected to the connector 41 of the mobile communication device 50 and to a connector 101 of the external device 100, respectively. The connector 61 is a small-sized USB micro-B type connector according to a specification in which the mobile communication device 50 is defined as a client configured to be supplied with power from the external device 100, and has a fourth pin for an ID signal being open. The mobile communication device 50 is supplied with power from the external device 100 through “VBUS” of a first pin of the connector 61. The connector 61 has a second pin “D minus (D−)” and a third pin “D plus (D+)” provided for a pair of balanced signals of USB data that is a bidirectional high-speed communication signal. At an initial state before the direction of the communication is determined, the lines “D−” and “D+” are in receiving states of high impedance at both the mobile communication device 50 and the external device 100. Infinity symbols indicated in parentheses added to signal reference names in FIG. 1 represent impedance at the initial state. (USB host cable 70)

The USB host cable 70 has a connector 71 and a connector 72 to be connected to the connector 41 of the mobile communication device 50 and to the connector 101 of the external device 100, respectively. The connector 71 is a small-sized USB micro-A type connector according to a specification in which the mobile communication device 50 is defined as a host configured to supply the external device 100 with power, and has a fourth pin for the ID signal being grounded. The mobile communication device 50 supplies the external device 100 with power through “VBUS” of a first pin of the connector 71.

### (Earphone Cable 90)

The earphone cable 90 is of a stereo type having earphones 92 and 93. The earphones 92 and 93 are driven by earphone signals “Lch” and “Rch” from terminals “L” and “R” of the plug 91, respectively. The plug 91 has a terminal “G” for a return line of those signals. The earphone 92 has internal impedance of low resistance, and so does the earphone 93.

### (Conversion Cable 80)

The conversion cable 80 has a connector 81 and a jack 82 to be connected to the connector 41 of the mobile communication device 50 and to the plug 91 of the earphone cable 90, respectively. The connector 81 is a small-sized USB micro-B type connector. The connector 81 has an unused first pin. The connector 81 has a second pin for the earphone signal “Lch” for driving the earphone 92, and is connected to a terminal L of the jack 82. The connector 81 has a third pin for the earphone signal “Rch” for driving the earphone 93, and is connected to a terminal R of the jack 82.

The conversion cable 80 further has a talk switch 83, a Zener diode 84 and a microphone 85 connected between a fourth pin (microphone signal) and a fifth pin (ground) of the connector 81 in parallel.

The microphone 85 has internal impedance of low resistance. The Zener diode 84 is for protection use. A voice output of the microphone 85 is a signal of a small amplitude within a range in which the Zener diode 84 is rendered off in both directions, and is not distorted by an effect of the Zener diode 84. Each time a user pushes the talk switch 83, the mobile communication device 50 alternatively controls a switchover between states where talking is allowed and banned.

The mobile communication device 50 should be configured to sense a connection with the USB client cable 60, the USB host cable 70 or the conversion cable 80, to sense the earphone cable 80 connected to the end of the conversion cable 80, and to sense a push of the talk switch 83 included in the conversion cable 80.

The mobile communication device 50 has to sense the connection with the earphone cable 90 in both cases where the earphone cable 90 is connected to the conversion cable 80 from the beginning and where the earphone cable 90 is connected to the conversion cable 80 at any timing after the conversion cable 80 alone is connected to the mobile communication device 50. The mobile communication device 50 has to sense a push of the talk switch 83 at any timing after sensing the connection with the conversion cable 80.

Then, the mobile communication device 50 configured to automatically sense a kind of cable after one of the above cables is connected will be explained.

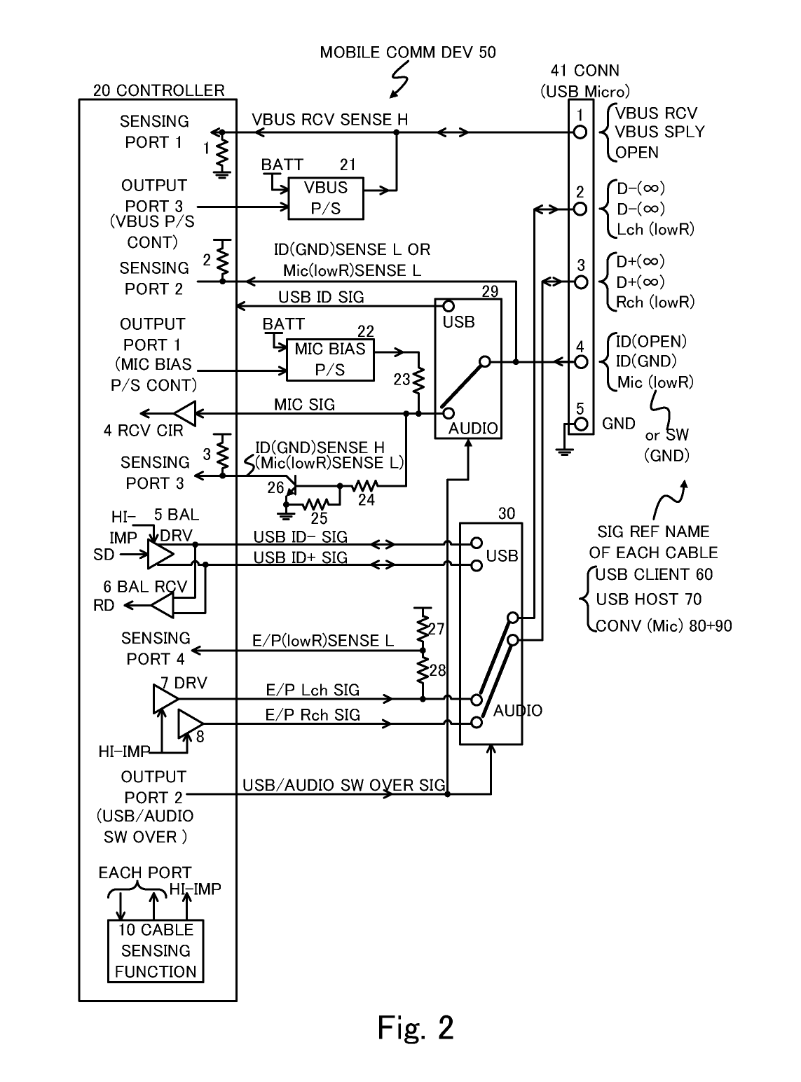

FIG. 2 is a block diagram of related portions of the mobile communication device 50 of the embodiment of the present invention. The mobile communication device 50 is constituted by a controller 20, a VBUS power supply 21, a microphone bias power supply 22, resistors 23, 24, 25, a transistor 26, resistors 27, 28, analog switches 29, 30, the connector 41, etc.

The connector 41 is a small-sized USB micro connector. FIG. 2 shows, with the reference numerals of the terminals, reference names of signals transmitted by three kinds of the cables connected to the outside, etc. Each of the terminals is indicated with an upper reference name, a middle reference name and a lower reference name of signals transmitted by the USB client cable 60, the USB host cable 70 and the series of the conversion cable 80 and the earphone cable 90, respectively. These reference names of the signals are same as those explained with reference to FIG. 1. Impedance conditions of respective terminals are shown in parentheses.

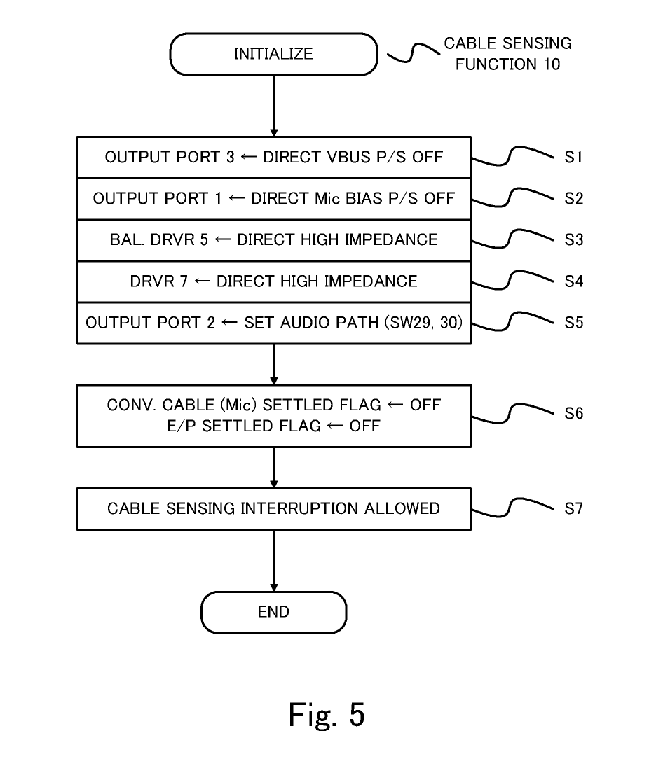

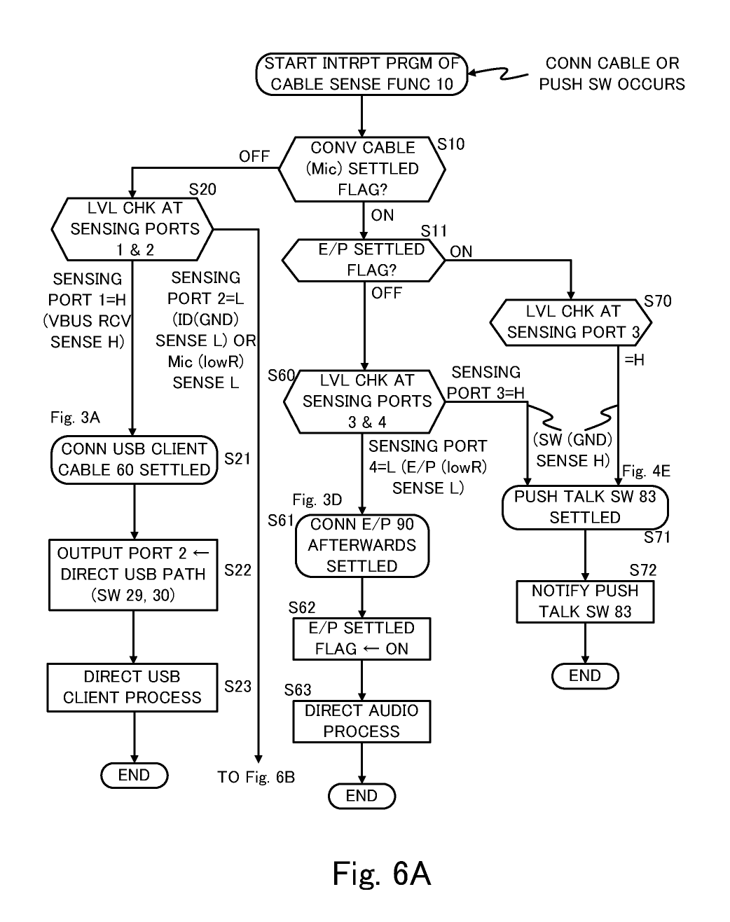

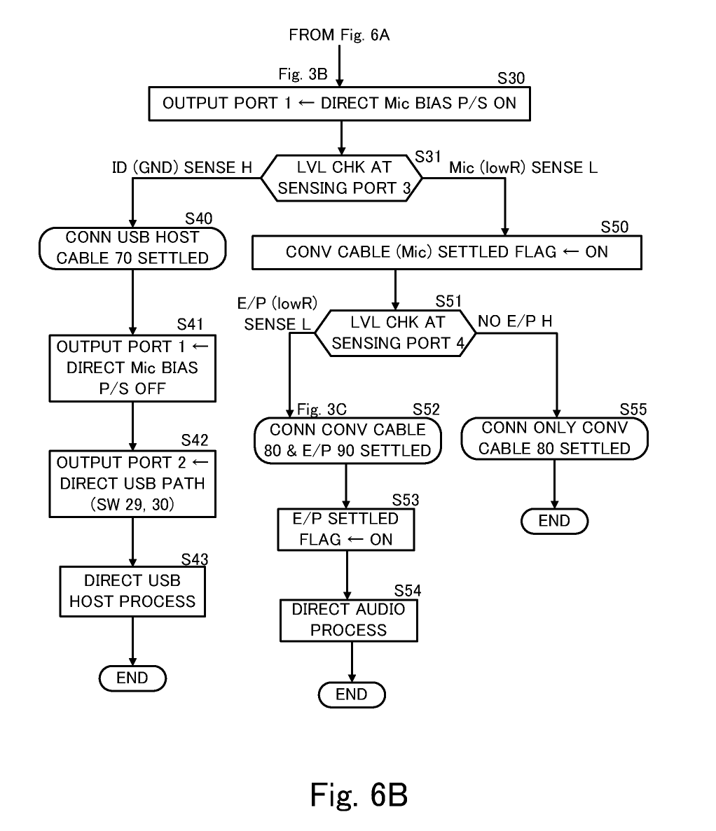

The controller 20 has a CPU, a ROM, a RAM, an I/O port, etc. which are not shown. The controller 20 runs a program stored in the ROM. One of functions implemented by the above program is a cable sensing function 10, which will be explained later (with reference to FIGS. 5 and 6) in detail.

The I/O port has sensing ports 1-4 on its input side. The CPU is provided with a change of a signal applied to each of the sensing ports 1-4 as an interruption signal so as to cause an interruption. An interruption program checks a level (high or low) of the interruption signal, and judges which of the input ports the interruption has come from.

The I/O port has output ports 1-3 on its output side. The controller 20 controls high impedance states of drivers from the output ports.

### (Sensing Port 1)

The sensing port 1 is connected to the first terminal of the connector 41, and changes a state depending on a kind of cable connected to the outside. The sensing port 1 is pulled down through a resistor 1, and resides at a low level in an initial state before a cable is connected to the sensing port 1. Upon being supplied with the VBUS power from the outside after the USB client cable 60 is connected to the connector 41, the sensing port 1 changes its voltage level from low to high and causes an interruption to the CPU, and the CPU senses the interruption.

In a case where the USB host cable 70 is connected to the connector 41, the mobile communication device 50 renders the VBUS power supply 21 off as an initial state as explained next, and the sensing port 1 remains at the low level. The VBUS power supply 21 is controlled by the output port 3 so as to be turned on/off. Although being configured to supply the outside with the VBUS power in a case where the mobile communication device 50 is a host, the VBUS power supply 21 does not supply the first terminal of the connector 41 with the VBUS power as initially being rendered off.

In a case where the conversion cable 80 is connected to the connector 41, the first terminal is rendered open and the sensing port 1 remains at the low level.

As shown in FIG. 2, the sensing port 1 is given a signal reference name “VBUS RCV SENSE H”, which implies that the last character “H” indicates a physical high level and that the signal given the reference name before “H” is supposed to be logically active at a high voltage level. As signal reference names with voltage level indications should be similarly interpreted hereafter, a signal given a reference name before the last character “L” is supposed to be active at the low level.

### (Sensing Port 2)

The sensing port 2 is connected to a fourth terminal of the connector 41, and changes its state depending on a kind of cable connected from the outside. The sensing port 2 is pulled up through a resistor 2, and its voltage level is rendered high if no cable is connected to the sensing port 2. If the USB client cable 60 is connected to the connector 41, the sensing port 2 is provided with the ID signal being open and its voltage level thereby remains high.

If the USB host cable 70 is connected to the connector 41, the sensing port 2 is provided with the ID signal being grounded and thus the sensing port 2 changes its voltage level from high to low and causes an interruption. Further, if the conversion cable 80 is connected to the connector 41, the sensing port 2 is connected to the microphone 85 of low impedance and thereby changes its voltage level from high to low and causes an interruption. Thus, the interruption caused by the sensing port 2 allows the controller 20 to sense one of the USB host cable 70 and the conversion cable 80 connected to the connector 41, while which one is still being unknown.

### (Sensing Port 3)

The sensing port 3 is configured to sense which one of the USB host cable 70 and the conversion cable 80 is connected to the connector 41. First, a circuit related to the sensing port 3 will be explained. The microphone bias power supply 22 is primarily configured to supply bias for shifting dc voltage so that an output signal of the microphone 85 of the conversion cable 80 falls into a dynamic range of a receiving circuit 4. The microphone bias power supply 22 of the present invention is connected to the fourth terminal of the connector 41 through the resistor 23 and an audio path of the analog switch 29. The fourth terminal is also connected to the resistor 2 for pulling up the sensing port 2.

The cables that can be connected from the outside of the fourth terminal each have respective impedance values which are different from one another. Thus, an audio terminal of the analog switch 29 is provided with a voltage level that changes depending upon a combination of a kind of the cables and an on/off state of the microphone bias power supply 22. If the conversion cable 80 (Mic (low R)) is connected to the connector 41 and the microphone bias power supply 22 is rendered off, the audio terminal is provided with a voltage divided by the resistor 2 and the microphone (low resistance), and the resistors 24 and 25 are chosen so that the transistor 26 is rendered off at that voltage.

The resistors 24 and 25 are chosen so that, if the same conversion cable 80 (Mic (low R)) is connected to the connector 41 and the microphone bias power supply 22 is rendered on, the voltage is raised at the audio terminal through the resistor 23 and the transistor 26 is rendered on.

Further, if the USB host cable 70 (ID (grounded)) is connected to the connector 41, the audio terminal is provided with a voltage remaining at the ground level, and the transistor 26 is rendered off. The sensing port 3 senses the state of the transistor 26. Although the on/off state of the transistor 26 is sensed, it is allowable to directly measure the voltage level at the audio terminal of the analog switch 29 for judgment.

According to a specific procedure for sensing the cables, an interruption is caused at the sensing port 2 so that one of the USB host cable 70 (ID (grounded)) and the conversion cable 80 (Mic (low R)) connected to the connector 41 is sensed, then the microphone bias power supply 22 is turned on through the output port 1 so that it is attempted to raise the voltage at the audio terminal of the analog switch 29.

If the fourth terminal of the connector 41 is connected to “ID (grounded)” of the USB host cable 70, the voltage level of the audio terminal remains at the ground level, the transistor 26 is turned off, the voltage level of the sensing port 3 is rendered high and it is judged that the USB host cable 70 is connected to the connector 41.

If the fourth terminal of the connector 41 is connected to the microphone 85 (low resistance) of the conversion cable 80, the voltage level of the audio terminal is raised and the transistor 26 is turned on upon the microphone bias power supply 22 being turned on, the voltage level of the sensing port 3 remains low and it is judged that the conversion cable 80 is connected to the connector 41.

The sensing port 3 also senses a push of the talk switch 83 included in the conversion cable 80. After the conversion cable 80 (Mic (low R)) being connected to the connector 41 is sensed, the microphone bias power supply 22 continues being on. If the talk switch 83 is pushed at any timing in such a state, the voltage level of the fourth terminal is rendered grounded, the transistor 26 is turned off and the sensing port 3 changes its voltage level from low to high so as to cause an interruption, and the CPU senses the interruption.

### (Sensing Port 4)

The sensing port 4 is configured to sense the earphone cable 90 (Lch (low resistance)). First, a circuit related to the sensing port 4 will be explained. Drivers 7 and 8 outputs an earphone Lch signal and an earphone Rch signal which are audio signals. The drivers 7 and 8 are connected to the second and third terminals of the connector 41 through an audio path of the analog switch 30 and drive the earphones 92 and 93 of the earphone cable 90, respectively.

The analog switch 30 is switched to the audio path for sensing a cable by means of the sensing port 4. The earphone Lch signal is pulled up through resistors 28 and 27. The midpoint between the resistors 28 and 27 is connected to the sensing port 4. At an initial state, output impedance of the driver 7 is initially rendered high. If no cable is connected, the voltage level of the sensing port 4 is initially high.

The controller 20 recognizes the difference of impedance among the USB client cable 60 (D-(infinity)), the USB host cable 70 (D-(infinity)), and the series of the conversion cable 80 and the earphone cable 90 (Lch (low resistance)) depending on the voltage level of the sensing port 4.

If the USB client cable 60 (D-(infinity)) or the USB host cable 70 (D-(infinity)) is connected, the voltage level of the sensing port 4 remains high. If the conversion cable 80 and the earphone cable 90 (Lch (low resistance)) are connected at the same time, the voltage level of the sensing port 4 changes from high to low, and causes an interruption due to the change. If the voltage level of the sensing port 4 is recognized to be low, the earphone cable 90 (Lch (low resistance)) being connected is sensed.

A balanced driver 5 and a balanced receiver 6 sends and receives, respectively, a pair of ID minus and ID plus signals of the USB. In an initial state before the direction of the USB data communication is determined, the cable sensing function 10 renders output impedance of the balanced driver 5 high. Similarly, the external device 100 that can communicate with the mobile communication device 50 through the USB initially renders impedance of the lines of the ID minus and ID plus signals high.

Thus, if one of the USB cables is connected to the connector 41, in the initial state of cable sensing, the line of the ID minus signal of the external device 100 is connected to the resistor 28 through the second terminal of the connector 41 and the audio path of the analog switch 30. As the external device 100 is in a high-impedance state and so is the driver 7, the impedance of the connected cable can be distinguished through the sensing port 4.

One of a plurality of the interruption factors described above, if having been caused, interrupts a program being run by the CPU, and the CPU then runs a program for processing the interruption. The program for processing the interruption checks a voltage level at each of the sensing ports and identifies which of the interruption factors has occurred so as to sense which of the cables is connected.

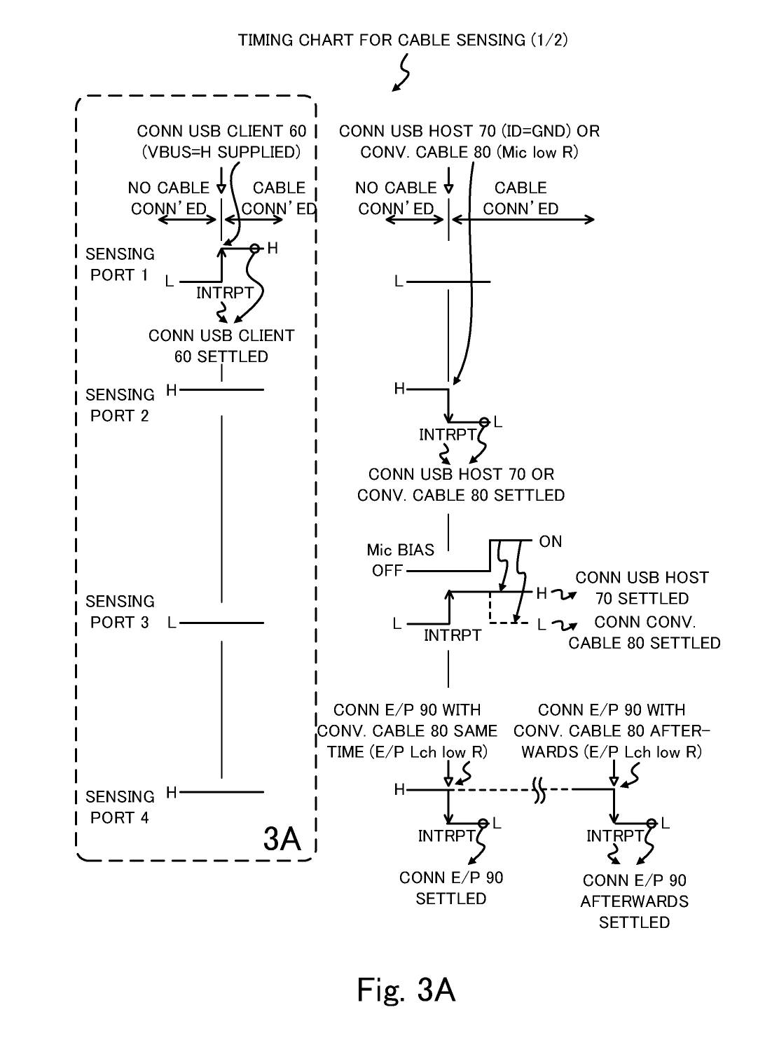

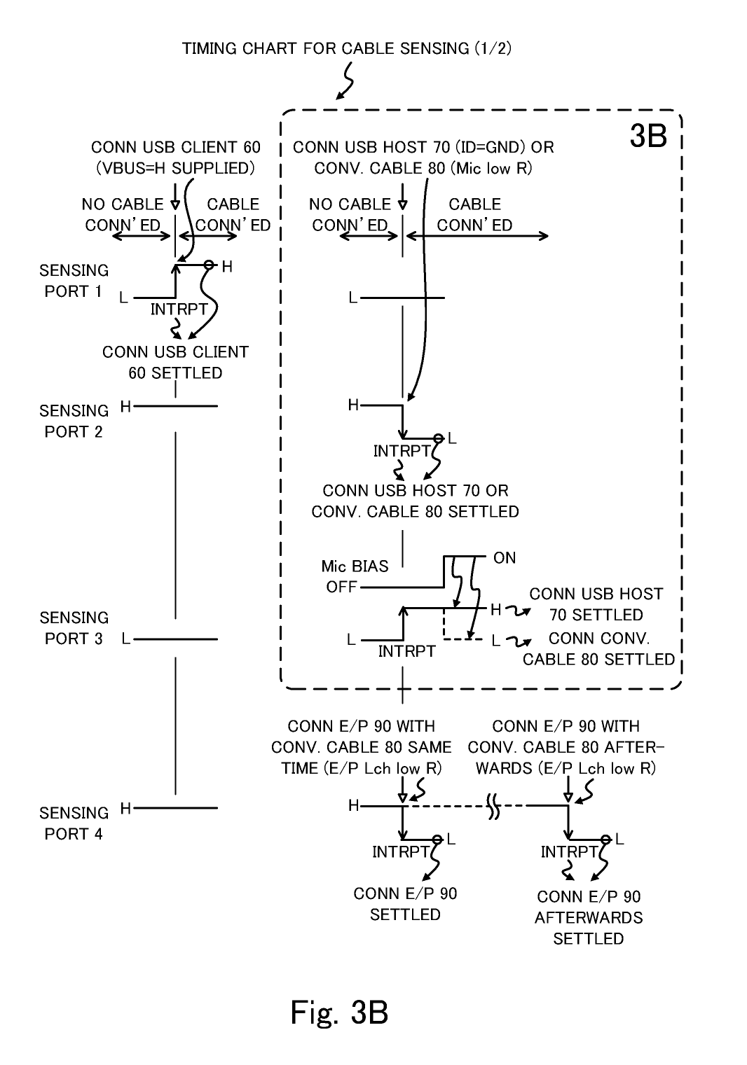

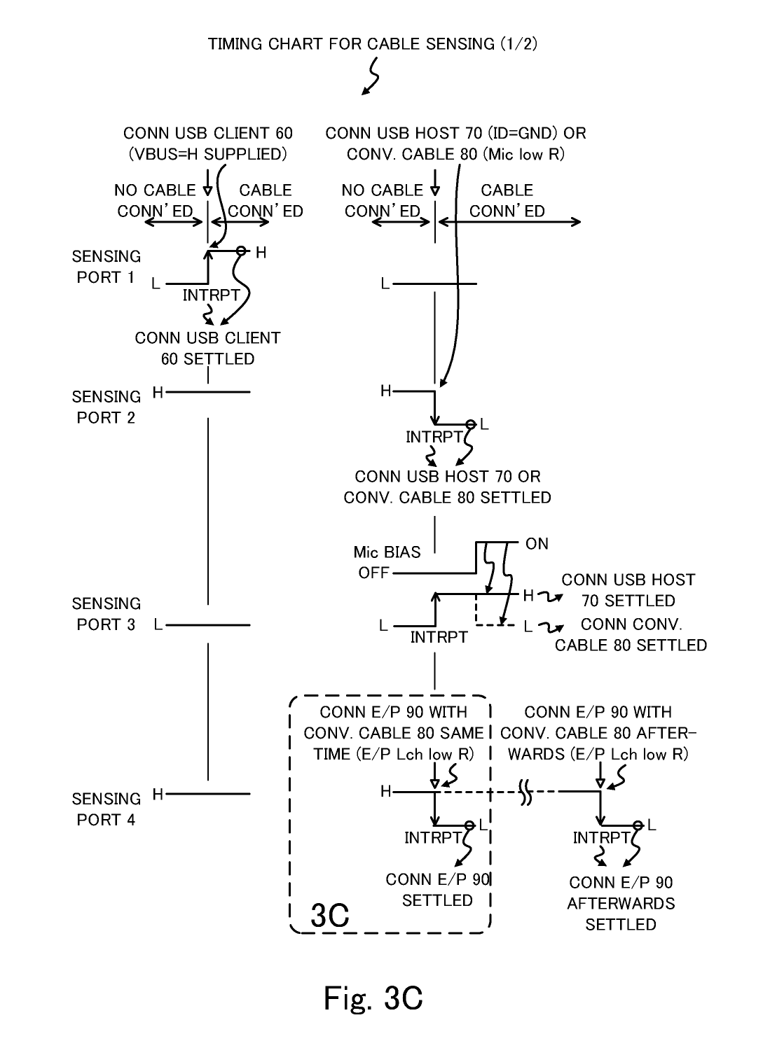

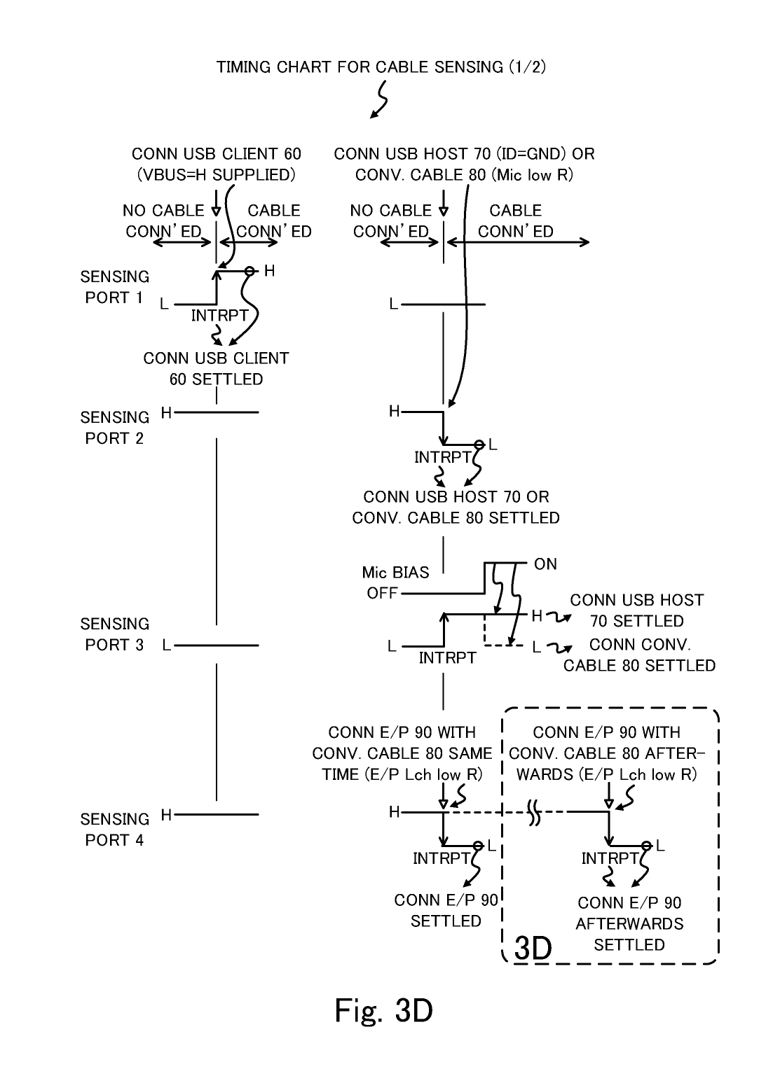

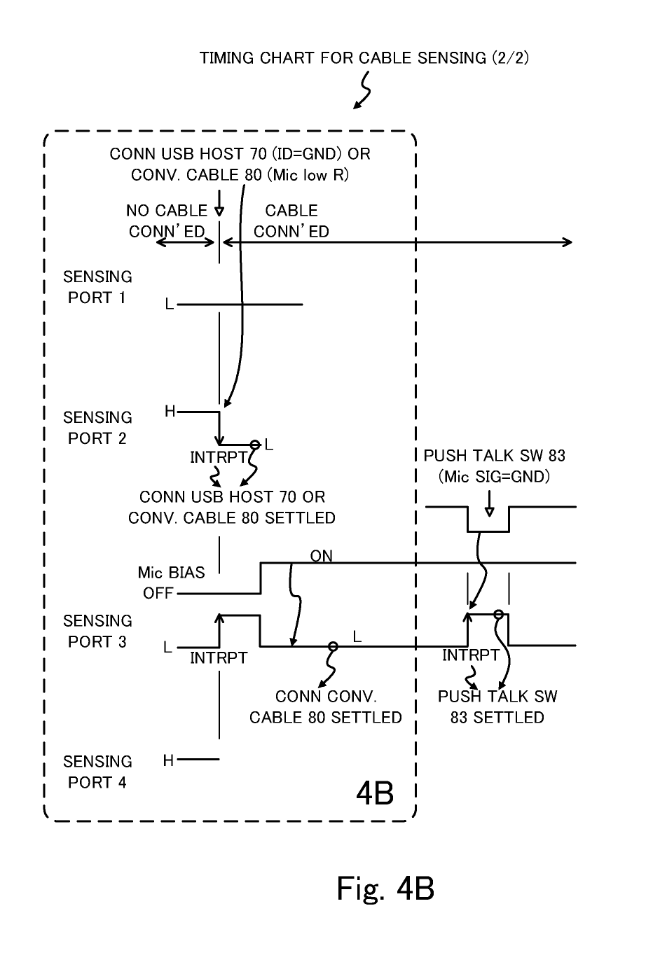

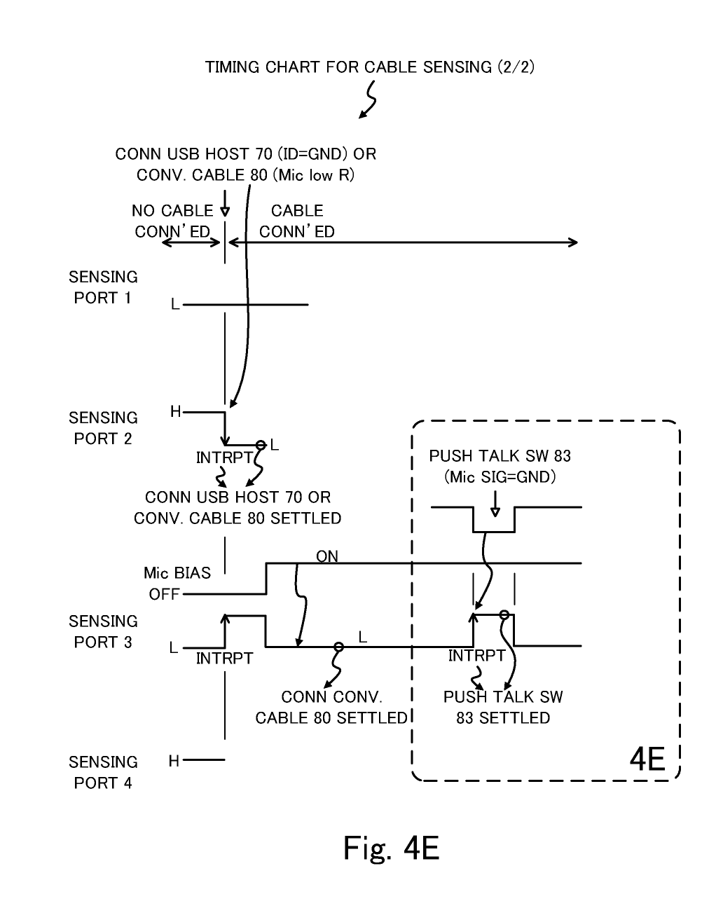

FIGS. 3A-4E are timing charts for sensing the cables by means of the mobile communication device 50, and mainly illustrate timings of interruptions upon each of the cables being connected. FIG. 3A shows a case where the USB client cable 60 is connected. FIG. 3B shows a case where the USB host cable 70 or the conversion cable 80 is connected. FIG. 3C shows a case where a series of the conversion cable 80 and the earphone cable 90 is connected. FIG. 3D shows a case where the earphone cable 90 is connected at any timing after the conversion cable 80 is connected. FIG. 4B shows a case where the conversion cable 80 is connected. FIG. 4E shows a case where the talk switch 83 is pushed at any timing.

Interruptions are caused at the timings shown in the drawings. The cable sensing function 10 that senses a kind of the cables each time an interruption is caused will be explained below. FIGS. 5-6B show flowcharts of the cable sensing function 10 of the mobile communication device 50 of the embodiment of the present invention. FIG. 5 and FIGS. 6A and 6B illustrate a flow of an initialization process performed before cable sensing and a flow of an interruption process performed after an event such as connecting a cable occurs, respectively.

As shown in FIG. 5, the cable sensing function 10 includes an initialization process that performs initialization before sensing a cable. Steps S1-S5 are aimed at hardware circuit elements shown in FIG. 2. First, the cable sensing function 10 directs the output port 3 to turn off the VBUS power supply (step 51). This is an initialization process before the host and client of the USB are not determined yet. Then, the initialization process directs the output port 4 to turn off the microphone bias power supply (step S2). That is, although being configured to primarily provide the microphone 85 with a bias voltage, the microphone bias power supply 22 is initially turned off before being used for cable sensing.

Then, the cable sensing function 10 renders the output impedance of the balanced driver 5 high (step S3). This is an initialization process before the direction of the USB bidirectional communication is not determined yet. Then, the cable sensing function 10 renders the output impedance of the driver 7 high (step S4). That is, although the driver 7 is configured to drive the earphones, its impedance is initially rendered infinite for level sensing through the sensing port 4 before being used for cable sensing.

Then, the cable sensing function 10 directs the output port 2 to set the audio path so as to set the switches 29 and 30 each to their respective audio paths. That is, although being primarily configured to switch over a destination of a signal that travels through the connected cable after the connected cable is distinguished between the USB cable and the audio cable, the switch 29 is initially set to the audio path before being used for cable sensing, and so is the switch 30.

Then, the cable sensing function 10 turns off a conversion cable (mic) settled flag and an earphone settled flag as internal flag processing implemented by software (step S6). The conversion cable (mic) settled flag indicates whether or not the conversion cable 80 has been connected. The earphone settled flag indicates whether or not the earphone cable 90 has been connected. Those flags are used for selectively processing interruptions in accordance with a cabling state in the interruption process described later (see FIGS. 6A and 6B). Then, the cable sensing function 10 allows a cable sensing interruption (step S7) and ends the initialization process.

As shown in FIG. 6A, an interruption signal is caused by an event such as connecting a cable from the outside to the mobile communication device 50 and pushing the talk switch, so that the interruption process starts. At first, the cable sensing function 10 checks the conversion cable (mic) settled flag and the earphone settled flag (steps S10-S11) so as to check the present cabling state. The cable sensing function 10 change the port at which what kind of interruption process has occurred is checked as described below.

If the conversion cable settled flag is off at the step S10, the cable sensing function 10 judges that no cable is connected. Assuming the timings shown in FIGS. 3A-3C, the sensing ports 1 and 2 will be checked at a step S20.

If the conversion cable (mic) settled flag is on at the step S10, and if the earphone settled flag is off at the step S11, the conversion cable 80 has already been connected. Thus, the flow moves on to a step S60 in an assumption that the earphone cable 90 may possibly be connected afterwards as shown in FIG. 3D and the talk switch 83 may possibly be pushed as shown in FIG. 4E.

If the conversion cable settled flag is on at the step S10, and if the earphone settled flag is on at the step S11, the conversion cable 80 and the earphone cable 90 have already been connected. Thus, the flow moves on to a step S70 in an assumption that the talk switch 83 may possibly be pushed as shown in FIG. 4E.

### (In Case of FIG. 3A)

A process at steps S10-23 will be explained in detail also with reference to the timing chart shown in FIG. 3A. As shown in FIG. 3A, if the USB client cable 60 is connected in a state where no cable has been connected, the voltage level of the sensing port 1 changes from low to high and causes an interruption so that an interruption program starts to run. After the steps S10 and S20, the cable sensing function 10 checks that the voltage level of the sensing port 1 is high (“VBUS RCV SENSE H”), and the connection of the USB client cable 60 is settled (step 521).

The sensing port 1 being at the high voltage level cannot be sensed until the external device provides the mobile communication device 50 with the VBUS power, even if the USB client cable 60 is connected, and can be sensed just after the VBUS power is provided.

As the connection of the USB client cable 60 is settled, the cable sensing function 10 sets a USB path to the output port 2 so that the switches 29 and 30 each change over to their respective USB paths (step S22). Then, the cable sensing function 10 directs a USB upper layer to perform a USB client process (step S23) and ends the flow.

### (In Case of FIGS. 3B and 3C)

As shown in FIG. 3B, if the USB host cable 70 is connected in a state where no cable has been connected, the voltage level of the sensing port 2 changes from high to low and causes an interruption so that the interruption program starts to run. After the steps S10 and S20, the cable sensing function 10 checks that the voltage level of the sensing port 2 is low (“ID (GND) SENSE L” or “Mic (low R) SENSE L”), and the connection of one of the USB host cable 70 and the conversion cable 80 (mic) is settled (step 521).

As which of them is connected is unknown, however, the cable sensing function 10 directs the output port 1 to turn the microphone bias power supply 22 on and attempts to raise the voltage at the audio terminal of the analog switch 29 (step S30 shown in FIG. 6B). The cable sensing function 10 checks a resultant voltage level at the sensing port 3, i.e., the output of the transistor 26 (step S31). If the voltage level is high (“ID (GND) SENSE H”), the connection of the USB host cable 70 is settled (step S40).

As it is settled, the cable sensing function 10 directs the output port 1 to turn the microphone bias power supply 22 off (step S41) and sets the USB path to the output port 2 so that the switches 29 and 30 each change over to their respective USB paths (step S42). Then, the cable sensing function 10 directs the USB upper layer to perform a USB host process (step S43) and ends the flow.

If the voltage level checked at the sensing port 31 at the step S31 is low (“Mic (low R) SENSE L”), the connection of the conversion cable 80 is settled, and the cable sensing function 10 turns the conversion cable settled flag on (step S50).

As shown in FIG. 3C, the cable sensing function 10 checks whether or not the earphone cable 90 is connected at the end of the conversion cable 80 by checking a voltage level at the sensing port 4 (step S51). If the voltage level of the sensing port 4 is low (“E/P (low R) SENSE L”), the connection of the earphone cable 90 to the end of the conversion cable 80 is settled (step S52), and the earphone settled flag is turned on (step S53). Then, the cable sensing function 10 directs an audio upper layer to perform an audio process (step S54) and ends the flow.

Although the interruptions are caused at the sensing ports 2, 3 and 4 at the same time in the states shown in FIGS. 3B and 3C, the cable sensing function 10 can sense the connection of each of the cables by checking the voltage levels at the sensing ports 2, 3 and 4 in order of the steps starting from S20.

If the voltage level of the sensing port 4 is high (“No E/P H”), the connection of the conversion cable 80 without a connection of the earphone cable 90 is settled (step S55), and the flow ends. (In case of FIG. 3D)

Then, a case where the earphone cable 90 is connected afterwards in a state where only the conversion cable 80 has already been connected will be explained. If the earphone cable 90 is connected afterwards, the voltage level of the sensing port 4 changes from high to low and causes an interruption so that the interruption program starts to run.

As the conversion cable 80 has already been connected, the conversion cable settled flag has been turned on at the step S50. Thus, the conversion cable settled flag being on is checked at the step S10 shown in FIG. 6A, the earphone settled flag being off is checked at the step S11, and the flow moves on to the step S60. In this case, the flow moves on to the step S60 in an assumption that the earphone cable 90 may possibly be connected afterwards as shown in FIG. 3D and the talk switch 83 may possibly be pushed as shown in FIG. 4E.

If the voltage level of the sensing port 4 is low (“E/P low R SENSE L”) at the step S60, the connection of the earphone cable 90 connected afterwards is settled (step S61), and the earphone settled flag is turned on (step S62). Then, the cable sensing function 10 directs the audio upper layer to perform the audio process (step S63) and ends the flow.

### (In Case of FIG. 4E)

As the talk switch 83 is contained in the conversion cable 80, the push of the talk switch 83 can be sensed only if either the conversion cable 80 alone or the series of the conversion cable 80 and the earphone cable 90 has already been connected.

If the talk switch 83 is pushed in the state where the conversion cable 80 alone has already been connected, the voltage level of the sensing port 3 changes from low to high and causes the interruption program to start, and the flow moves on through the steps S10 and S11 to the step S60. Then, the sensing port 3 being at the high voltage level (“SW (GND) SENSE H”) is checked and the push of the talk switch 83 is settled (step S71).

Further, if the talk switch 83 is pushed in the state where the series of the conversion cable 80 and the earphone cable 90 has already been connected, the voltage level of the sensing port 3 changes from low to high and causes the interruption program to start, and the flow moves on through the steps S10 and S11 to the step S70. Then, the sensing port 3 being at the high voltage level (“SW (GND) SENSE H”) is checked and the push of the talk switch 83 is settled (step 571).

If the push of the talk switch 83 is settled (step S71), the cable sensing function 10 notifies the audio upper layer of the push of the talk switch (step S72) and ends the flow. The audio upper layer is, although not shown, configured to alternatively switch over between a start and a stop of talking each time being notified of the push of the talk switch.

According to the present invention, as described above, the connections of the USB client cable 60, the USB host cable 70, the conversion cable 80 for the audio use and the earphone cable 90 connected to the end of the conversion cable 80, which can be connected from the outside to the mobile communication device, can be automatically sensed, and so can be the push of the talk switch 83 contained in the conversion cable 80 as well.

Further, the microphone bias power supply primarily configured to supply the microphone 85 contained in the conversion cable 80 with power can be turned on/off so that whether the USB host cable 70 or the conversion cable 80 is connected to the mobile communication device 50 can be checked. Further, the microphone bias power supply can be turned on/off so that the push of the talk switch contained in the conversion cable 80 can be sensed.

The particular hardware or software implementation of the present invention may be varied while still remaining within the scope of the present invention. It is therefore to be understood that within the scope of the appended claims and their equivalents, the invention may be practiced otherwise than as specifically described herein.

What is claimed is:

1. A mobile communication device configured to be connected to a first external cable, comprising:
a connector configured to be connected to the first external cable;
an interface having a first sensing port, the interface having a first circuit connected to the connector and to the first sensing port, the first circuit being configured such that the first sensing port is provided with a voltage level that changes depending on whether the connector is open or connected to the first external cable; and
a controller connected to the first sensing port, the controller being configured to perform an interruption process so as to perceive the connection of the first external cable upon sensing a change of the voltage level at the first sensing port.

2. The mobile communication device according to claim 1, further configured to be connected to a second external cable, wherein
the connector is further configured to be connected to one of the first external cable and the second external cable,
the first circuit is further configured such that the voltage level provided to the first sensing port changes depending on whether the connector is open or connected to one of the first external cable and the second external cable,
the interface further has a second sensing port and a second circuit connected to the connector and to the second sensing port, the second circuit including a power source, the second circuit being configured such that the second sensing port is provided with a voltage level that changes after the power source is turned on depending on whether the connector is connected to the first external cable or the second external cable, and
the controller is further connected to the second sensing port, the controller being further configured to turn the power source on and off, the controller being further configured to perform the interruption process so as to perceive the connection of one of the first external cable and the second external cable upon sensing the change of the voltage level at the first sensing port, the controller being further configured to distinguish which of the first external cable and the second external cable is connected to the connector by sensing the voltage level at the second sensing port after turning the power source on.

3. The mobile communication device according to claim 1, wherein
the first external cable is configured to be connected to a component at an end of the first external cable,
the interface further has a second sensing port and a second circuit connected to the connector and to the second sensing port, the second circuit being configured such that the second sensing port is provided with a voltage level that changes after the first external cable is connected to the connector depending on whether or not the first external cable is connected to the component at the end of the first external cable, and
the controller is further connected to the second sensing port, the controller being further configured to perform an interruption process after the first external cable is connected to the connector so as to perceive the connection of the first external cable and the component upon sensing a change of the voltage level at the second sensing port.

4. The mobile communication device according to claim 2, wherein
the second external cable includes a switch,
the second circuit is further configured such that the voltage level provided to the second sensing port changes after the connector is connected to the second external cable and the power source is turned on depending on whether the switch is turned on or off, and
the controller is further configured to perform an interruption process so as to perceive that the switch is turned on upon sensing a change of the voltage level at the second sensing port.

5. The mobile communication device according to claim 1, wherein the first circuit further includes a power source configured to supply the outside of the mobile communication device with power through the connector and the first external cable, the power source being configured to be controlled by the controller so as to be turned off before the controller senses the change of the voltage level at the first sensing port.

6. The mobile communication device according to claim 2, wherein the second external cable includes a microphone, and the power source is configured to provide the microphone with a bias voltage upon the second external cable being connected to the connector.

7. The mobile communication device according to claim 3, wherein the component is an earphone.

8. The mobile communication device according to claim 4, wherein the second external cable includes a microphone connected parallel to the switch that is configured to switch over between states where talking is allowed and banned.
